(19) United States
(12) Patent Application Publication
(10) Pub. No.: US 2024/0347226 A1
(43) Pub. Date: Oct. 17, 2024

(54) HIGH VOLTAGE CABLE WITH COMPOSITE CORE FOR LOW OPERATING TEMPERATURE

(71) Applicant: EPSILON COMPOSITE, GAILLAN (FR)

(72) Inventor: Baptiste GARY, HOURTIN (FR)

(21) Appl. No.: 18/579,658

(22) PCT Filed: Jul. 11, 2022
(86) PCT No.: PCT/EP2022/069259

§ 371 Date: Jan. 16, 2024

(30) Foreign Application Priority Data
Jul. 16, 2021 (FR) FR2107690

(51) Int. Cl. H01B 1/24; H01B 1/02; H01B 7/00; H01B 7/18

(52) U.S. Cl. CPC H01B 1/24; H01B 1/023; H01B 7/0009; H01B 7/1825

(57) ABSTRACT

A high-voltage cable includes a composite core surrounded by an electrical conductor, wherein it is limited to 95° C.±5%, and the electrical conductor is made of hard aluminum with an aluminum ratio Ra of between 6 and 19, wherein Ra is calculated according to the following rule: Ra=Sc/Sa×100, where Sc is the cross-section of the composite core of the cable and Sa is the cross-section of the conductive aluminum of the cable. This makes it possible to obtain a cable with the same mass as current low-temperature cables, the same external diameter, at least the same mechanical strength and equivalent thermal expansion. This results in a cable in which the aluminum cross-section is increased by between 20% and 40% with the same mass.

### TECHNICAL FIELD OF THE INVENTION

The technical field of the invention is that of conductor cables for a high voltage, that is more than 20 KV, overhead power supply line and more particularly the structure of said cable.

The present invention relates in particular to high-voltage cables for low operating temperatures.

### TECHNOLOGICAL BACKGROUND OF THE INVENTION

Today, high-voltage cables are classified into two categories:
low operating temperature conductors, that is <95° C.,
high operating temperature conductors which can reach up to 220° C.

Low temperature conductors should not be used above 95° C., as most comprise hard aluminium, such as 1350-H19 aluminium, which permanently loses its mechanical strength (annealing) at temperatures above 95° C. The table in FIG. 1 shows the different conductivities and tensile strengths of conductors of different types of aluminium according to their maximum operating temperature. To limit this loss of strength, their nominal temperature should be restricted accordingly, taking their exposure to the weather during operation into account. Most of these low-temperature high-voltage cables have a conventional steel core, known as ACSR (aluminium-conductor steel-reinforced cable). In addition, their high coefficient of thermal expansion means that bending becomes significant at high temperatures.

High-temperature conductor cables are manufactured from annealed aluminium (or aluminium alloys) which can withstand temperatures in excess of 95° C. However, this annealed aluminium has less mechanical strength than hard aluminium, so it is necessary to use a core with greater mechanical strength. This annealed aluminium has the advantage of being less resistant electrically. Moreover, it is more expensive to produce as it requires annealing, which also increases its environmental impact.

To increase mechanical strength of the cables, a core is placed in the centre thereof. This core is comprised either of a conventional steel or aluminium alloy core for low-temperature cables, or of a steel or metal matrix composite or polymer core for high-temperature cables. Composite cores are more expensive, more complex and more polluting to manufacture. In particular, carbon fibres are fairly expensive, especially high-strength ones.

Furthermore, for a given cable diameter, the core limits proportion of conductive aluminium and therefore the current that can circulate in the cable. The core should therefore be as small in diameter as possible.

A compromise should therefore be found between the different restrictions of mechanical strength and electrical resistance, temperature, core diameter, cost and environmental impact.

Thus low-temperature cables are nowadays produced with or without a core. As aluminium mechanical strength increases with its electrical resistance and price, coreless cables have either low mechanical strength and electrical resistance (for example 1350-H19 aluminium AACs) or high mechanical strength and electrical resistance (for example AL3 aluminium AAACs). Cables with a core are made with a conventional steel core and a hard or alloyed aluminium, thus they are cheap. However, for a given cable diameter, the steel core has a large diameter, which limits the cable ampacity by as much, that is the maximum current-carrying capacity in amperes, and since steel has a large density, it makes the conductor heavier.

Given their high cost and low coefficient of thermal expansion, composite cores are only used in high-temperature cables.

### SUMMARY OF THE INVENTION

The invention provides a solution to the problems previously discussed, by providing a low-temperature cable capable of flowing at least 15% more amperes therethrough and at an iso-operating temperature of the cable than a conventional solution, at a reasonable price, and with thermo-mechanical properties equivalent to ACSR solutions.

The invention also makes it possible, at iso amperage, to generate at least 20% less Joule effect loss than the conventional solution, and thereby to have a significantly reduced environmental impact, by reducing the carbon footprint during operation of the cable, and also by reducing inductive currents.

The high-voltage cable according to the invention comprises a composite core surrounded with an electrical conductor, it is characterised in that it is limited to 95° C.±5%, that is a low-temperature aluminium, that the electrical conductor is hard aluminium with a hard aluminium ratio Ra of between 6 and 19 and preferably between 8 and 15, where Ra is calculated according to the following rule: Ra=Sc/Sa×100 where Sc is the cross-section area of the composite core of the cable and Sa is the cross-section area of the conductive aluminium of the cable. The aluminium ratio is calculated according to the following rule: Ra=Sc/Sa×100 where Ra is the aluminium ratio, Sc is the cross-section area of the cable composite core and Sa is the cross-section area of the cable conductive aluminium. This results in a cable with the same mass as current low-temperature cables, the same external diameter, at least the same mechanical strength and equivalent thermal expansion. A cable is thus obtained with an aluminium cross-section area increased by between 20% and 40%, preferably 25% to 35% for an identical diameter.

Since the composite has a higher strength than steel, the cable can be more strongly preloaded upon installing. This stronger preload compensates for the higher coefficient of thermal expansion (CTE) of the cable when the same is working below the thermal knee point. The composite therefore makes it possible to maintain a sag close to that of current cables while having a larger aluminium cross-section area. On the other hand, the CTE above the thermal knee point will be lower, which makes it possible to ensure sagging of the cable in operation, and especially at high temperature, less than or equal to sagging of a standard steel solution, which is nevertheless more rigid.

The invention also makes it possible to reduce stresses associated with storage on reels and to reduce the winding diameters to less than 140 times the diameter of the composite material core.

Advantageously, the composite core is comprised of a matrix and a carbon fibre core surrounded with an insulating layer. This insulating layer protects the carbon from galvanic couple.

Advantageously, the matrix has a glass transition temperature Tg<160° C. As the cable is used at <95° C., with respect to a high-temperature composite solution having a thermal resistance>160° C., there is a wide choice of matrices serving to impregnate the structural reinforcing fibres to form the composite material.

The manufacturing cost of these low-temperature matrices is low, because they are standard components for volume markets, such as the pultruded reinforcement profiles for spars of wind turbine blades: a price up to three times lower than that of so-called high-temperature matrices (Tg>160° C.).

On the other hand, they require low energy consumption to initiate complete polymerisation, for example in a pultrusion die, in less than 2 minutes and preferably between 60 and 90 seconds, the difference in curing temperature between a high-temperature matrix and a standard matrix is less than 15% to 30% for the same curing time, resulting in energy savings during manufacture.

These low-temperature matrices also have better resistance to moisture regain, with lower glass transition losses than matrices with glass transition temperatures Tg>160° C. For these low-temperature matrices, wet saturation at 90° C. results in a glass transition temperature loss of 20 to 30° C., with respect to high-temperature matrices where wet saturation at 90° C. results in a glass transition temperature loss of 30 to 60° C. High-temperature matrices degrade rapidly at high temperature, whereas at 95° C. there is virtually no degradation of the material.

Similarly, these matrices have better crack propagation resistance in the material (impact resistance), with G1C>80 J/m² and preferably >100 J/m² for low-temperature matrices versus 50 to 70 J/m² for high glass transition temperature Tg matrices.

This increase in crack propagation resistance when using low-temperature cable has some advantages for the following reasons.

Hard aluminium offers less protection against impacts than cables with annealed aluminium, especially when handling the cables, whether in production, during transport, upon installing or during maintenance periods. This is because annealed aluminium will absorb the impact generated on the cable by deformation and therefore limit effect on the composite core in the cable by virtue of:
A Vickers hardness of 25 HV1/10±5 for annealed aluminium versus 45 HV1/10±5 for hard aluminium.
An elongation at break or ductility of the material greater than 15% and preferably >20% for annealed aluminium versus less than 5% and preferably between 1 and 3% for hard aluminium.

The choice of hard aluminium therefore significantly increases the risk of cable breakage by propagation of an external impact to the composite core. It is therefore appropriate for the matrix used to be reinforced against defect propagation within the scope of the invention where hard aluminium is used. The criterion of resistance to propagation of a defect in the matrix therefore becomes predominant and requires a higher G1C to obtain a solution as durable as annealed aluminium cables.

Low Tg matrices have thermal damage, known as thermolysis, temperatures of between 16° and 180° C., ensuring a level of thermal resistance in operation at the maximum temperature of use over time that is much higher than for high Tg matrices. These high Tg matrices have a level of thermolysis less than or equal to their Tg, generating a risk of resistance over time, especially to high risk compression and bending forces when used in operation above thermolysis temperatures.

Preferably, the glass transition temperature Tg of the matrix is such that 90° C.<Tg<140° C.

According to a first alternative, the matrix is an epoxy matrix. Thus, low-temperature epoxy matrices have a glass transition temperature Tg<160° C. and preferably: 90° C.<Tg<140° C.

According to a second alternative, the matrix is a vinyl matrix. The vinylester matrices have a glass transition temperature Tg<160° C. and preferably: 90° C.<Tg<140° C.

According to a third alternative, the matrix is a reactive acrylic matrix. For example, reactive acrylic matrices with a glass transition temperature Tg<140° C. may be used.

According to a fourth alternative, the matrix is a thermoplastic matrix. This type of matrix makes it possible both to optimise recycling of the cable core at the end of its life and to increase impact resistance with respect to a composite with a thermosetting matrix: reduction by a factor of 2 or 3 of the surface area of delamination at ISO impact force.

Advantageously, the insulating layer has a volume of between 40% and 80% of the total volume of the composite core. Carbon fibres are the most expensive element in the core and the most polluting; by thus limiting their proportions, a sufficiently strong core can be obtained at an affordable price. For example, glass fibres are ten times less polluting to produce than carbon fibres, so pollution is limited by limiting amount of carbon fibres in the core.

According to a first embodiment, the insulating layer comprises glass fibres. These glass fibres may be of E or S grade. Glass fibres are cheaper and more flexible than carbon. The flexibility of glass fibres makes the core more flexible and enables it to be wound on smaller reels.

According to a second embodiment, the insulating layer comprises silica fibres.

According to a third embodiment, the insulating layer comprises basalt fibres.

Advantageously, the carbon fibres have a tensile strength<4500 MPa. This composite core makes it possible to use carbon fibres with a lower mechanical strength by virtue of better mechanical properties of 1350-H19 aluminium. As these carbon fibres are less expensive, this makes it possible to reduce price of the composite obtained.

Advantageously, the cable has a diameter of between 10 and 60 mm, preferably between 15 mm and 45 mm. In high-temperature conductors with a composite core and annealed aluminium, 90% of the cable strength is due to the composite and 10% to the aluminium; in the version provided in FIG. 3, 60% of the cable strength is due to the aluminium and 40% to the composite. This better distribution allows the cable to hold together better in the event of damage to the composite.

This absorption of forces by the hard aluminium optimises strength of the composite core. For example, with a strength of <1000 MPa (FIG. 2 configuration, last column) and preferably 800 MPa±200 MPa (FIG. 3 optimised configuration) for the composite core in a favoured embodiment. The reduction in strength absorbed by the composite makes it possible to significantly increase amount of insulating fibre with lower moduli than carbon and therefore to optimise the bending radii permissible by the cable upon installing, making it possible to limit the risks of overstress leading to breakage of the composite core upon installing.

According to a first arrangement, the aluminium conductors are trapezoidal in shape. This shape gives a more compact cross-section area than with round wires.

According to a first arrangement, the aluminium conductors are Z-shaped. This shape gives a more compact cross-section area than with round wires.

Advantageously, the composite core is produced by pultrusion.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a comparative table of different types of aluminium,

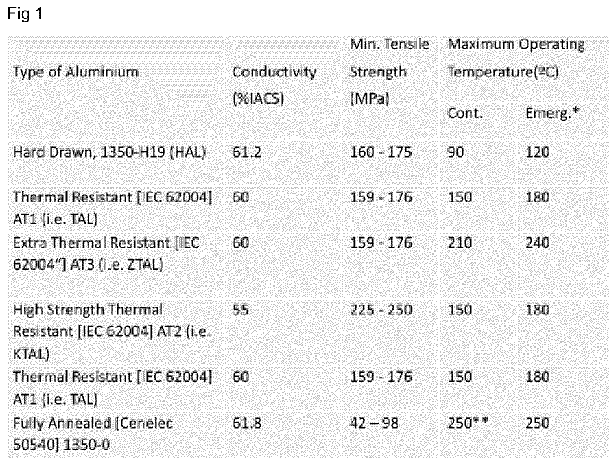

FIG. 2 is a comparative table of an example of a cable according to the invention with those of the state of the art,

FIG. 3 is a table illustrating characteristics of two cable embodiments according to the invention.

### DETAILED DESCRIPTION

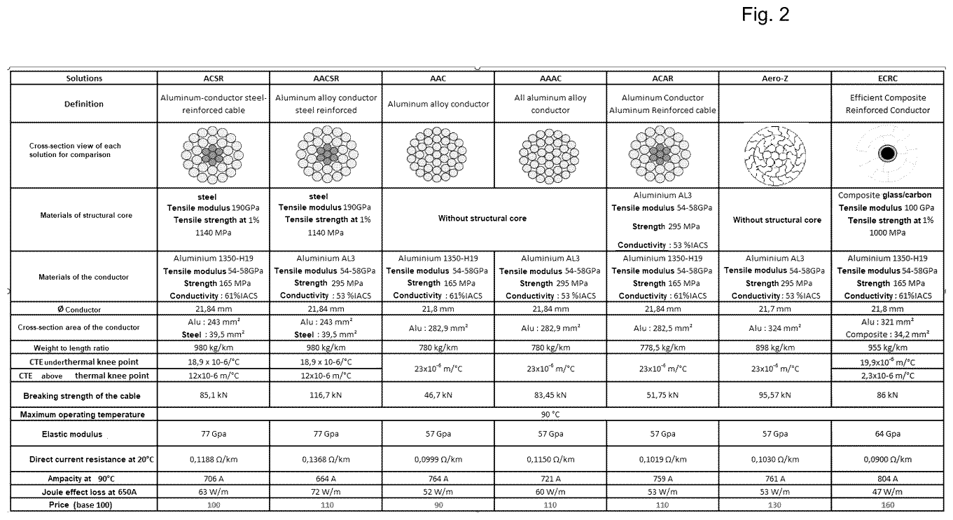

The cable according to the invention provides better intrinsic performance than a cable of the same diameter in the state of the art, as illustrated in the example of FIG. 2.

In this table seven types of low-temperature high-voltage cable can be seen:
Aluminium-Conductor Steel-Reinforced (ACSR) cable,
Aluminium Alloy Conductor Steel-Reinforced (AACSR) cable,
Aluminium Alloy Conductor (AAC) cable,
All Aluminium Alloy Conductor (AAAC) cable,
Aluminium-Conductor Aluminium-Reinforced (ACAR) cable,
Aero-Z™ aluminium conductor cable
a cable according to the invention which is an Efficient Composite Reinforced Conductor (ECRC).

It can be seen from this table that the ECRC cable according to the invention, for an equivalent diameter and weight, has a conductor cross-section area very close to that of an all-aluminium cable, since in this example aluminium represents more than 90% of the core cross-section area. The result is a cable with low electrical resistance, but with better ampacity and Joule effect loss than other cables. All these characteristics are achieved at a price that is only 30% to 60% more expensive, the extra cost being compensated for by savings in operating costs. In addition, the elastic modulus and coefficient of thermal expansion are better than 100% aluminium solutions.

Indeed, the invention also offers a significant gain for the operator, by virtue of the limitation of electrical resistance with respect to conventional solutions, and by virtue of its controlled extra cost for the network operator upon installing.

The real gain in operation of composite core solutions with respect to aluminium conductor steel-reinforced (ACSR) cables and high-voltage composite-reinforced conductors (HVCRC or ACCC) is visible in the following table.

At iso amperage, iso voltage, for the same duration and the same length of conductor, the table below shows that the 30% gain in electrical resistance is reflected in Joule effect loss in kWh (calculation according to CIGRE's TB265 on Life Cycle Assessment).

| | | | | | TABLE | | |
|---|---|---|---|---|---|---|---|
| | | | | | Joule effect loss | | |
| | | | | | | | Gain |
| | | | | | | | compared to |
| | | | | | | | ACSR in €/km |
| | | | | Duration | | Gain compared | (reference |
| | Calculator | T° at | Resistance | of | | to ACSR in | price: |
| Cable | case | 350A * | at T° | calculation | | kWh/km | 0.05 €/kWh) |
| ACSR | 50% load | 49° | 0.1336 | 8760 h | 430 098 | 0 | 0 |
| | for ACSR | C. | Ω/km | | kWh/km | | |
| Cable | (350A) | 46° | 0.1029 | | 331 266k | 98 833 | 4942 |
| according to | | C. | Ω/km | | Wh/km | kWh/km | €/km |
| invention | | | | | | | |
| HVCRC | | 46° | 0.1012 | | 325 793 | 104 305 | 5215 |
| or ACCC | | C. | Ω/km | | kWh/km | kWh/km | €/km |

* Temperature calculated with: Ambient T°: 30° C.: wind speed: 0.61 m/s: Emissivity: 0.5; solar absorption: 0.5; solar radiation: 1000 W/m²

The real gain is a minimum of 20% on operating losses by the grid operator with respect to an ACSR solution, which amounts to generating less power (with respect to usual losses) for the same power transported, and therefore the same gain in carbon dioxide emissions during power generation.

However, aluminium conductor cables with a composite core (HVCRC: High Voltage Composite Reinforced Conductor or ACCC: Aluminium-Conductor Composite Core) are 2.5 times more expensive than ACSR cables, the market benchmark, and cables of the type described in the invention are between 1.5 and 2 times more expensive, preferably 1.7 times more expensive. However, by combining the gains in power lost through the Joule effect loss on composite solutions with respect to the ACSR solution in use by the grid operator, it appears that the invention allows amortisation between 1.5 and 3 times faster than the HVCRC or ACCC solution with iso ampacity, voltage and lengths, preferably 2.15 times faster.

TABLE

| | | Cost over | Return on investment |
|---|---|---|---|
| Cable | Price | ACSR | (gain in €/km) |
| ACSR | 3000 €/km | | |
| Cable according | 5000 €/km | 3 × 2000 €/km | 1.21 year (15 |
| to the invention | | | months) |
| HVCRC or ACCC | 7500 €/km | 3 × 4500 €/km | 2.59 years (31 |
| | | | months) |

Different combinations are possible for making the composite core, such as, for example, the use of low glass transition temperature (Tg) matrices of the epoxy-anhydride, vinyl ester or thermoplastic system type combined with a volume ratio of structural carbon reinforcement fibre in the first layer filled with cylindrical sections, in relation to the less structural, but surface insulating layer of 40% to 80% (in surface area) and an insulating layer of E or S grade glass fibre, or silica fibre, or basalt fibre or an insulating layer of thermoplastic fibre of, for example, PE HT (high tenacity polyethylene) or para-aramid type.

For a first exemplary embodiment of the composite core, use is made of:
an epoxy matrix comprising: a bisphenol-A-epichlorohydrin and/or bisphenol-F-epichlorohydrin base, mixed with a tetrahydromethylphthalic anhydride or hexahydro-4-methylphthalic anhydride hardener, mixed with 1-(2-hydroxypropyl) imidazole and/or 2,4,6-tris(dimethylaminomethyl) phenol accelerator,
Graphil G37-800 and/or Toray T700 and/or Toho Tenax STS type high-strength carbon fibres and/or Toray T800 type high-modulus carbon fibres or equivalent with similar rigidity/strength ratios of +10% and preferably +5%
with insulating SE3030 3B glass fibre and/or SE1500 3B and/or SE2020 3B glass fibre.

Since ozone degradation of bisphenol A can have a significant impact on the service life of high-voltage cables under operating conditions<100° C., an optimised solution consists in eliminating bisphenol A from the matrix formulation in order to limit ozone degradation of the composite material core. This problem is not necessary for high-temperature HVCRC or ACCC cables, where ozone is dissociated into dioxide and oxide above 100° C. To overcome this problem, the invention consists in favouring formulations without bisphenol A, for example in a second exemplary embodiment of the composite core below, which comprises:
an epoxy matrix with a bisphenol-F-epichlorohydrin base, mixed with a tetrahydromethylphthalic anhydride or hexahydro-4-methylphthalic anhydride hardener, mixed with 1-(2-hydroxypropyl) imidazole and/or 2,4,6-tris(dimethylaminomethyl)phenol accelerator,
Graphil G37-800 and/or Toray T700 and/or Toho Tenax STS type high-strength carbon fibres and/or Toray T800 type high-modulus carbon fibres or equivalent with similar rigidity/strength ratios of ±10% and preferably ±5%, and
insulating fibres of SE3030 3B glass fibres and/or SE1500 3B glass fibres and/or SE2020 3B glass fibres.

A third embodiment of the composite core is possible with:
a vinyl matrix comprising bisphenol-A epoxy-based vinyl ester resin and/or novolac epoxy-based vinyl ester resin,
Graphil G37-800 and/or Toray T700 and/or Toho Tenax STS type high-strength carbon fibres and/or Toray T800 type high-modulus carbon fibres or equivalent with similar rigidity/strength ratios of ±10% and preferably ±5%, and
insulating fibres of Basaltex KV11 and/or KV12 and/or KV42 basalt fibres.

A fourth embodiment of the composite core is particularly optimised for recycling, since depolymerisation of the matrix at the end of its life is possible by chemical treatment, grinding of the carbon fibre for incorporation in thermoplastic compounds, and melting of the PE HT fibre for reuse in the thermoplastic industry, for example in thermoplastic injection or extrusion.

This composite core consists of:
an ELIUM® C595 E or 591 type matrix+a mixture of initiators and additives,
Graphil G37-800 and/or Toray T700 and/or Toho Tenax STS type high-strength carbon fibres and/or Toray T800 type high-modulus carbon fibres or equivalent with similar rigidity/strength ratios of ±10% and preferably ±5%,
Honeywell Spectra HT PE insulating fibres.

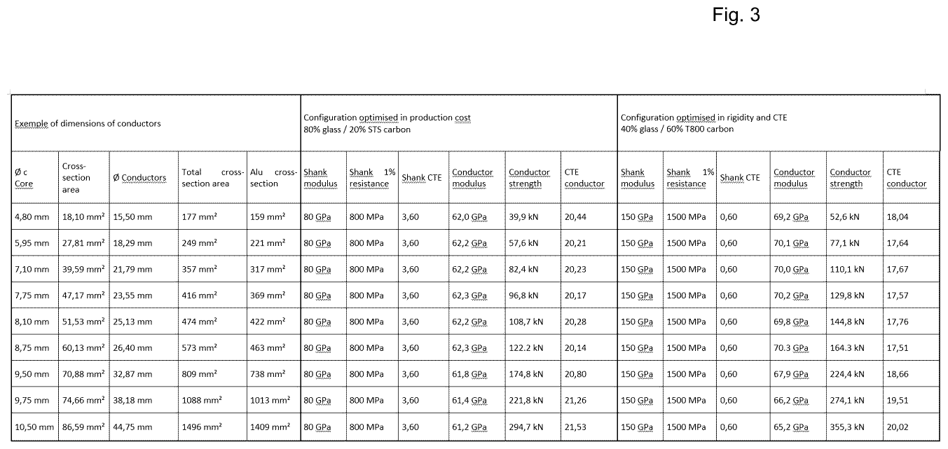

The table in FIG. 3 shows examples of the minimum and maximum performance expected for each diameter existing on the market in the first embodiment as a function of the variation in the ratio of so-called high-strength carbon fibres (STS) or so-called high-rigidity carbon fibres (T800) to the ratio of insulating fibres.

The second column relates to a cable with a core comprising 80% glass fibres and 20% carbon fibres, this solution being optimised in terms of cost. The third column relates to a cable with a core comprising 40% glass fibres and 60% carbon fibres. This solution is 70% more expensive than the previous one, but it allows greater spans between towers in the case of river or canyon crossings.

In all these examples illustrating the invention, the aluminium ratio is between 6 and 13, which makes it possible to limit proportion of carbon fibres and therefore the price, and to have the same mechanical strength as an ACSR cable but with lower electrical resistance and therefore lower Joule effect loss.

1. A high-voltage cable comprising a composite core surrounded with an electrical conductor, wherein the high-voltage cable is limited to 95° C.±5° C., the electrical conductor is hard aluminium with an aluminium ratio Ra of between 6 and 19, where Ra is calculated according to the following rule: Ra=Sc/Sa×100 where Sc is a cross-section area of the composite core of the cable, and Sa is a cross-section area of the conductive aluminium of the cable.

2. The high-voltage cable according to claim 1, wherein the composite core is comprised of a matrix and a carbon fibre core surrounded with an insulating layer.

3. The high-voltage cable according to claim 2, wherein the matrix has a glass transition temperature Tg<160° C.

4. The high-voltage cable according to claim 3, wherein the glass transition temperature Tg of the matrix is such that 90° C.<Tg<140° C.

5. The high-voltage cable according to claim 2, wherein the matrix is an epoxy matrix.

6. The high-voltage cable according to claim 2, wherein the matrix is a vinyl matrix.

7. The high-voltage cable according to claim 2, wherein the matrix is an acrylic reactive matrix.

8. The high-voltage cable according to claim 2, wherein the matrix is a thermoplastic matrix.

9. The high-voltage cable according to claim 2, wherein the insulating layer has a volume of between 40% and 80% of a total volume of the composite core.

10. The high-voltage cable according to claim 2, wherein the insulating layer comprises glass fibres.

11. The high-voltage cable according to claim 2, wherein the insulating layer comprises silica fibres.

12. The high-voltage cable according to claim 2, wherein the insulating layer comprises basalt fibres.

13. The high-voltage cable according to claim 2, wherein the carbon fibres have a tensile strength<4500 MPa.

14. The high-voltage cable according to claim 1, characterised in that it wherein the high-voltage cable has a diameter of between 10 and 60 mm.

15. The high-voltage cable according to claim 1 wherein the aluminium conductors are trapezoidal in shape.

16. The high-voltage cable according to claim 1, wherein the aluminium conductors are Z-shaped.

17. The high-voltage cable according to claim 1, wherein the composite core is produced by pultrusion.

18. The high-voltage cable according to claim 1, wherein the high-voltage cable has a winding diameter of less than 140 times the diameter of the composite material core.

19. The high-voltage cable according to claim 1, wherein a thermal ageing stress generates a loss of Tg strictly less than 30° C. in wet saturation at 90° C.

20. The high-voltage cable according to claim 1, wherein the high-voltage cable has a crack propagation resistance, G1C>80 J/m².

21. The high voltage cable according to claim 1, wherein the high-voltage cable has a tensile strength 60% due to aluminium and 40% due to composite.
